(19) United States
(12) Patent Application Publication
(10) Pub. No.: US 2022/0388510 A1
(43) Pub. Date: Dec. 8, 2022

(54) Cruise Control System and Method

(71) Applicant: Bendix Commercial Vehicle Systems LLC, Elyria, OH (US)

(72) Inventor: Thomas S. MILLER, JR., Lagrange, OH (US)

(21) Appl. No.: 17/337,539

(22) Filed: Jun. 3, 2021

(51) Int. Cl. B60W 30/14; B60W 40/105; B60W 50/12

(52) U.S. Cl. CPC B60W 30/143; B60W 40/105; B60W 50/12; B60W 2520/06; B60W 2554/40

(57) ABSTRACT

A cruise control system is provided with the ability to inhibit operation of a cruise control resume function which returns a vehicle to a target vehicle speed. The resume inhibition is inhibited when values of vehicle parameters exceed threshold values, such as a road wheel angle being greater than a threshold angle, detection of an object such as another vehicle adjacent to the vehicle, and/or a vehicle speed being lower than a threshold speed. The ability to inhibit the cruise control resume function enhances safety by avoiding unexpected or otherwise undesired vehicle acceleration when the steering wheels turned at a large angle and an adjacent object is present, thereby minimizing the chances of the turning vehicle colliding with the adjacent object.

### BACKGROUND AND SUMMARY OF THE INVENTION

The present invention relates to driver assistance systems, and in particular to cruise control system functions in commercial vehicles such as tractor-trailer trucks, box trucks, buses, and the like.

A driver assistance system which maintains a vehicle's speed at a target speed set by the driver, is well known as a “cruise control” system. Cruise control systems typically have manually actuated controls by which the driver can turn the cruise control system on or off, set the target vehicle speed, increase or decrease the target vehicle speed. Such systems also typically have a “resume” feature by which the driver can manually re-engage the cruise control system and resume the target vehicle speed after an event which has required the cruise control system to be disengaged and the driver to take over manual control of the vehicle speed, for example, as a result of the driver's having applied the brake pedal to avoid a collision.

It is known in the art for some cruise control systems to be further provided with an “auto-resume” functionality, which further assists the driver by increasing the vehicle speed back to the target speed without the driver having to manually actuate a “resume” switch. In such systems the acceleration of the vehicle back up to the target speed may be self-initiated by the cruise control system based on the system's determination that certain vehicle operating parameters are met, or in response to other signals such as a brief the driver's brief depression of the vehicle's accelerator pedal.

Some cruise control systems having an auto-resume functionality have the capability to initiate the acceleration of the vehicle back to the target speed from a very low vehicle speed, with some systems being able to resume speed from a standstill. Moreover, if the cruise control system has not been turned off, then even if the vehicle is stopped for an extended period of time the auto-resume function may initiate acceleration. This acceleration may be strong as, due to the nature of commercial vehicle powertrains, the highest vehicle acceleration is typically at the at the lowest speeds.

A potential problem with cruise control systems with a resume or an auto-resume functionality is that the acceleration of the vehicle back to the target speed potentially may be initiated in a manner not expected by the driver. For example, if, when the vehicle is being operated at a low speed or stopped for an extended period of time and the driver has input a high steering angle (i.e., the wheels of the steering axle are turned substantially away from the longitudinal axis of the vehicle) in preparation for turning off the road into a business for a delivery, the driver may forget the cruise control system is still in an active state. In such a state, if the resume function of the cruise control system begins to operate the vehicle could rapidly accelerate. If the steering wheels are turned at the time the rapid acceleration begins, the vehicle may impact an adjacent vehicle or object or cause an accident such as a vehicle roll-over.

The present invention addresses this and other problems with known cruise control systems by incorporating the steering angle of the wheels of the steering axle (the “road wheel angle”) and inputs from a side-looking radar proximity sensing system into the cruise control systems operational constraints. This solution is readily incorporated at low cost into vehicles which already have a steering wheel angle sensor whose output may be used to as an indication of the current road wheel angle, and lateral radar sensors. Steering wheel angle sensors are often found in commercial vehicles equipped with electronic stability control systems.

An example embodiment of the present invention is a system in which the vehicle speed and steering angle and the outputs of side-looking radar sensors are inputted to the cruise control system, and if the vehicle is moving a speed below a predetermined threshold speed, the road wheel angle is greater than a predetermined angle and a vehicle or object is detected by the side-looking radar sensors, the auto-resume function would be inhibited or canceled. This would require the driver to take over control of the vehicle's acceleration and thus avoid an unexpected sudden acceleration of the vehicle.

In a more sophisticated embodiment of the present invention, the resume functionality may be permitted at low vehicle speed and/or high road wheel angle, but the amount of acceleration permitted during execution of the resume event may be limited based as a function of the amount of road wheel angle. For example, low road wheel angles may allow the cruise control resume function to command a high level of acceleration, but as the road wheel angle increases or after exceeding a threshold road wheel angle, the vehicle acceleration may be progressively limited to prevent excessive vehicle lateral acceleration and allow the driver time to respond to avoid a collision.

In another embodiment, upon determining the resume functionality should be at least partially inhibited in the vehicles current operating state (e.g., at a standstill with a high road wheel angle and with an adjacent vehicle or object detected, the cruise control system may output commands to limit the output torque of the vehicle's powertrain. Similarly, the vehicle mass and/or mass distribution may be used in the resume functionality processing, for example to determine a roll-over threshold and limit the powertrain torque output accordingly. Such an implementation could be simplified in vehicles which are equipped with an electronic stability control system which already takes into account vehicle mass to mitigate potential vehicle rollover.

Preferably, in any embodiment of the present invention, even if the resume functionality is inhibited by the cruise control system in accordance with the sensed vehicle operating parameters, the driver would be provided the ability to override a powertrain torque output limitation as needed, for example by simply depressing the accelerator pedal.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of an embodiment of the present invention.

FIG. 2 is a flow chart of an embodiment of the present invention.

### DETAILED DESCRIPTION OF THE DRAWINGS

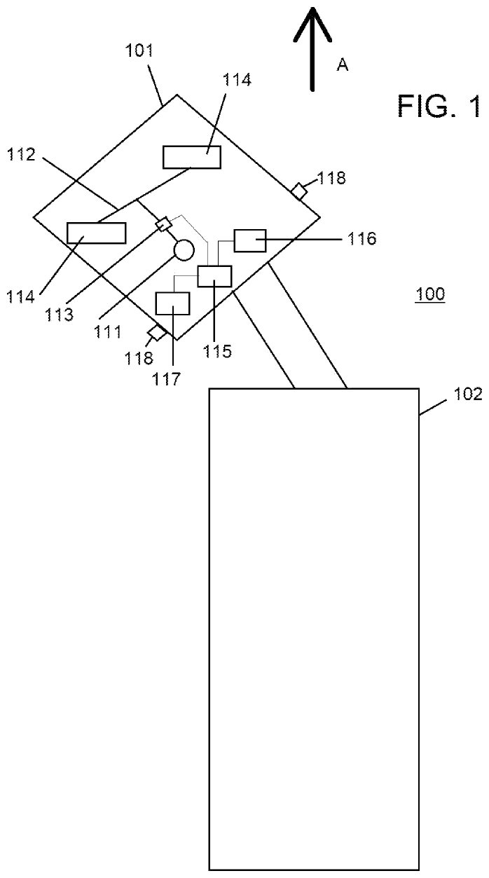

FIG. 1 is a schematic illustration of a commercial vehicle 100 having a cruise control in accordance with the present invention. The commercial vehicle 100 includes a tractor 101 connected to a trailer 102. A driver's steering wheel 111 is connected to a steering linkage 112. A steering angle sensor 113, located between the steering wheel 111 and the steering linkage 112, senses the amount of rotation of the steering wheel and generates an output signal indicative of the road wheel angle of the steering axle wheels 114 relative to the longitudinal axis of the tractor 101.

The output steering angle sensor 113 is received at a cruise control controller 115. The cruise control controller 115 may be a standalone electronic control unit having its own processor, memory and related hardware for processing of cruise control logic stored in the controller, or may be integrated with other vehicle controllers, such as a powertrain controller.

The cruise control controller 115 also receives vehicle operating parameters pre-stored in a vehicle memory 116 and/or obtained via a vehicle network (e.g., a CANBus) to which other vehicle controllers are connected. Examples of vehicle operating parameters of interest include vehicle speed in the forward direction A, vehicle lateral acceleration, road wheel angle, status of the states of the driver-actuable cruise control operating switches, tractor mass, trailer mass, tractor and trailer geometry (e.g., tractor and trailer length, axle positions, location of the trailer pivot point on the tractor, current angle of the trailer relative to the tractor, etc.). The cruise control controller 115 also receives signals from a side-looking radar system having side sensors 118 when the presence of an adjacent vehicle or other object is detected. The present invention is not limited to radar-based side sensors, but may use other sensing technologies such as acoustic and optical sensors.

As a part of the operation of the cruise control controller 115, the controller executes a program (discussed further below) which determines vehicle operating commands for operation of the vehicle's powertrain. These operating commands are sent to the vehicle' powertrain controller 117, which in this embodiment includes an engine, transmission and drive axles and wheels (not shown for clarity), for execution.

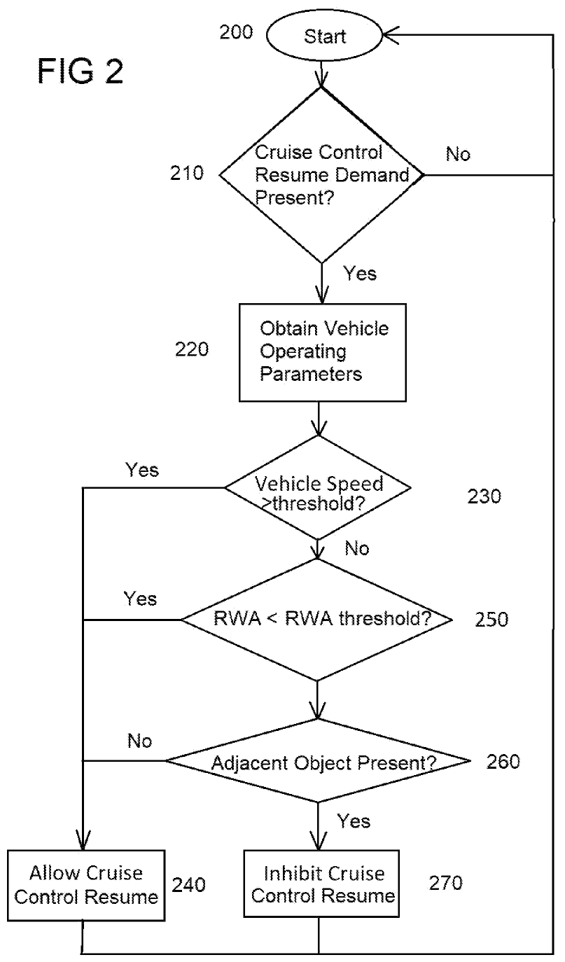

FIG. 2 shows a flow chart of a portion of the processing logic of a cruise control system, the portion being directed to resume inhibiting processing. From the start 200, the cruise control system at step 210 determines whether there is currently a demand for resumption of a predetermined target vehicle speed, either from the driver or from the vehicle's controllers. If there is no resume demand, processing is terminated and control is returned to the start 200. If a resume demand is present, in step 220 the cruise control controller 115 obtains vehicle operating parameters from the vehicle memory and/or other vehicle sensors and/or controllers (such as a controller that receives speed signals from the vehicle's speed sensors and calculates the vehicle's speed).

In step 230 the vehicle's speed is compared to a threshold speed below which resumption of cruise control may be inhibited. In vehicle's equipped with so-called “stop-and-go” systems, the vehicle speed threshold may be set as low as zero speed. If the vehicle speed is greater than the threshold vehicle speed, control is shifted to step 240 so that the cruise control 115 allows the issuance of commands that would cause the vehicle to accelerate to resume the target vehicle speed. Control then returns to start 200. If the vehicle speed is less than the vehicle sped threshold, control is shifted to step 250.

In step 250 the controller compares the steering axle wheels' road wheel angle (RWA) derived from the output of steering angle output sensor 113 to a road wheel angle threshold value (RWA threshold). The determination of the road wheel angle is not limited being made by the cruise control controller 115, but may be performed in a separate controller and provided to the cruise control controller 115 as one of the vehicle operating parameters.

The road wheel angle threshold value may be a fixed value stored in vehicle memory 116 or elsewhere, such as in the cruise control controller 115). Alternatively, road wheel angle threshold value may be a variable threshold that is calculated based on vehicle operating parameters, such as tractor and trailer mass, geometry, current lateral acceleration, road slope (i.e., current vehicle roll angle relative to horizontal).

If the steering axle wheels' road wheel angle RWA is less than the road wheel angle threshold value RWA threshold, control is shifted to step 240, in which the cruise control controller 115 so that cruise control resume is permitted. Control is then passed back to the start 200.

If the steering axle wheels' road wheel angle RWA is greater than the road wheel angle threshold value RWA threshold, control is shifted to step 260, in which the cruise control controller 115 determines whether an object adjacent to the vehicle, such as another vehicle, has been detected.

If there is no detection of an object adjacent to the vehicle, control is shifted to step 240, in which the cruise control controller 115 allows the issuance of commands that would cause the vehicle to accelerate to resume the target vehicle speed. Control is then passed back to the start 200. If an object is detected adjacent to the vehicle, control is shifted to step 270 and the cruise control resume function is inhibited. Control is then passed back to the start 200.

In a further embodiment of the present invention, the FIG. 2 process may omit the vehicle speed portion, and instead utilize steering angle and object detection as cruise control resume processing inputs.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LISTING OF REFERENCE LABELS

100 vehicle
101 tractor
102 trailer
111 steering wheel
112 steering linkage
113 steering angle sensor
114 steering axle wheels
115 cruise control controller
116 vehicle memory
117 powertrain controller
118 side sensor

What is claimed is:

1. A vehicle cruise control system, comprising:
a cruise control controller configured to
determine whether a demand for operating the cruise control system to resume a target vehicle speed is present,
receive vehicle operating parameters from one or both of vehicle storage and other vehicle components, the vehicle operating parameters including a current road wheel angle, a road wheel angle threshold, and a determination of whether an object is present adjacent to the vehicle,
compare the current road wheel angle to the road wheel angle threshold, and if the current road wheel angle is greater than the road wheel angle threshold, inhibit output of cruise control resume,
if an object is detected adjacent to the vehicle, inhibit output of cruise control resume, and
if the current road wheel angle is less than the road wheel angle threshold and no object is detected adjacent to the vehicle, output commands to resume the target vehicle speed.

2. The vehicle cruise control system of claim 1, wherein
the cruise control controller is further configured to compare a current vehicle speed to a vehicle speed threshold, and if the current vehicle speed is less than the vehicle speed threshold, inhibit output of cruise control resume.

3. A method of operating a vehicle cruise control system, comprising the acts of:
determining whether a demand for operating the cruise control system to resume a target vehicle speed is present,
receiving vehicle operating parameters from one or both of vehicle storage and other vehicle components, the vehicle operating parameters including a current road wheel angle, a road wheel angle threshold, and a determination of whether an object or other vehicle is present adjacent to the vehicle,
comparing the current road wheel angle to the road wheel angle threshold, and if the current road wheel angle is greater than the road wheel angle threshold, inhibiting output of cruise control resume,
if the current road wheel angle is less than the road wheel angle threshold, comparing the current vehicle speed to the vehicle speed threshold, and if the current vehicle speed is less than the vehicle speed threshold, inhibiting output of cruise control resume,
if an object is detected adjacent to the vehicle, inhibiting output of cruise control resume, and
if the current road wheel angle is greater than the road wheel angle threshold and no object is detected adjacent to the vehicle, outputting commands to resume the target vehicle speed.

4. The vehicle cruise control system of claim 3, further comprising the act of:
comparing a current vehicle speed to a vehicle speed threshold, and if the current vehicle speed is less than the vehicle speed threshold, inhibit output of cruise control resume.
